(19) United States
(12) Patent Application Publication
(10) Pub. No.: US 2023/0160384 A1
(43) Pub. Date: May 25, 2023

(54) Pump Assembly with Self-Retained Valve Spring and Methods

(71) Applicant: SPM Oil & Gas Inc., Fort Worth, TX (US)

(72) Inventors: Richard D. Peer, Crowley, TX (US); Chandu Kumar, Fort Worth, TX (US)

(73) Assignee: SPM Oil & Gas Inc., Fort Worth, TX (US)

(21) Appl. No.: 17/535,273

(22) Filed: Nov. 24, 2021

(51) Int. Cl. F04B 53/10; F04B 19/22; F04B 53/22

(52) U.S. Cl. CPC F04B 53/1087; F04B 19/22; F04B 53/22

(57) ABSTRACT

A fluid end includes a fluid end block defining a chamber. A plunger is disposed in the chamber. An outlet fluid passage is formed in the fluid end block in communication with the fluid chamber. An inlet fluid passage formed in the fluid end block communicates with the fluid chamber. The inlet fluid passage includes a seat, an enlarged diameter downstream from the seat, and a neck downstream of the enlarged diameter. The neck has a lesser diameter than the enlarged diameter. An inlet valve is movably disposed in the inlet fluid passage and is sized and shaped to seal against the seat. A biasing member has a first and second end with respective first diameter and a second diameter disposed within the enlarged diameter. The second end is positioned against the neck. The second end diameter is greater than the neck.

### TECHNICAL FIELD

The present disclosure relates to pump assemblies and, in particular, valve assemblies for such pump assemblies.

### BACKGROUND

In hydraulic fracturing, and other similar applications, the pumping equipment used to pump fluid media into a well is an important part of the fracturing system and process. Reciprocating pump assemblies have been used for decades to propel a fluid media, typically a mixture of water, sand and chemicals, for example, into a well at high pressures and flow rates. Increasing demands of pressure pumping has required such pumps to evolve by increasing in size, horsepower rating, and pressure capabilities. As a result, designing pump assemblies to be reliable and easily maintained has become an increasingly important consideration.

Reciprocating pump assemblies typically include fluid end blocks with fluid inlet and outlet passages for the fluid media. Each of the fluid inlets and fluid outlets include a check valve to control the flow of fluid through the fluid end block. The fluid inlet check valve is biased in a closed position against a valve seat of the fluid inlet passage by a biasing member, which conventionally is a spring. The spring is retained in position by a retainer or valve stop that is manually positioned and fitted to the inlet passage. The spring and retainer are manually installed with hand tools, typically by one person, which is a difficult to perform task.

Due the nature of the pumping process and high forces generated in the fluid end block, the valve stop can loosen and move. This creates the potential of damaging the fluid end block and creating stress risers and may lead to loss of retention of the spring biasing member. In the case of the latter situation, the loose spring may cause internal damage to the other elements of the end block and may be pumped out of the fluid end block and into the well, which may create other undesirable effects.

U.S. Pat. No. 10,240,597 discloses a pump assembly with a fluid block. The fluid block includes inlet and outlet passages, each with a check valve. The check valve for the inlet passage is configured to permit entry of fluid into the fluid block and is biased in a closed condition until a predetermined pressure differential is generated by the pump in the fluid block. The check valve is biased by a spring that is kept in position with a retainer that spans the inlet passage. The retainer can be difficult to install and can be dislodged or moved, which as noted above, can result in damage to the fluid end of the pump assembly.

The foregoing background discussion is intended solely to aid the reader. It is not intended to limit the innovations described herein, nor to limit or expand the prior art discussed. Thus, the foregoing discussion should not be taken to indicate that any particular element of a prior system is unsuitable for use with the innovations described herein, nor is it intended to indicate that any element is essential in implementing the innovations described herein. The implementations and application of the innovations described herein are defined by the appended claims.

There is a need for an easily assembled and reliable biasing element for a fluid end of a pump assembly. Devices and methods according to the disclosure satisfy the need.

### SUMMARY

In one aspect, the disclosure includes a fluid end of a reciprocating pump assembly and a reciprocating pump assembly having a power end wherein the fluid end includes a fluid end block defining a fluid chamber. A plunger is reciprocally disposed in the fluid chamber to generate fluid pressure therewithin. An outlet fluid passage is formed in the fluid end block in fluid communication with the fluid chamber. An inlet fluid passage formed in the fluid end block is in fluid communication with the fluid chamber. The inlet fluid passage includes a valve seat, an enlarged diameter downstream from the valve seat, and a neck downstream of the enlarged diameter. The neck has a lesser diameter than the enlarged diameter. An inlet valve is movably disposed in the inlet fluid passage and sized and shaped to seal against the valve seat and a biasing member has a first end with a first diameter disposed on the inlet valve and a second end with a second diameter disposed within the enlarged diameter and seated inside and against the neck. The second end diameter is greater than the neck so as to be retained thereby within the inlet fluid passage.

In another aspect, the disclosure includes a method of assembling an inlet valve for a fluid end of a reciprocating pump assembly, the method including enabling access to a chamber of the fluid end, installing an inlet valve into an inlet fluid passage of the fluid end, inserting a biasing member into the chamber, advancing the biasing member into a position within the inlet fluid passage by rotating the biasing member and into engagement with the inlet valve with a first end thereof, and wherein the biasing member is engaged with a neck of the inlet fluid passage with a second end thereof, whereby the shape size of the second end and the neck holds the biasing member in the inlet fluid passage.

### BRIEF DESCRIPTION OF THE DRAWINGS

FIG. 1 is an elevation view of a reciprocating pump assembly according to an exemplary embodiment, the reciprocating pump assembly including a fluid end.

FIG. 2 is a section view of the fluid end of FIG. 1 according to an exemplary embodiment, the fluid end including a fluid end block or housing and inlet and outlet valves.

FIG. 3 is a perspective view of a biasing member according to the disclosure.

FIG. 4 is a cut away perspective view of an inlet valve according to the disclosure.

FIG. 5 is a cut away perspective view of an inlet valve according to the disclosure with a biasing member shown in a partially installed condition.

FIG. 6 is a cut away side view of an inlet valve according to the disclosure with a biasing member shown in an installed condition.

FIG. 7 is a flow chart of a method of installing a biasing member into a fluid end according to the disclosure.

### DETAILED DESCRIPTION

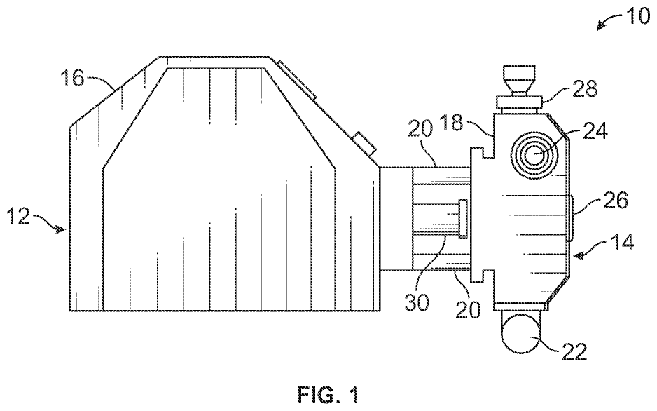

Now referring to the drawings, wherein like elements refer to like reference numbers, there is illustrated in FIG. 1 an exemplary embodiment of a reciprocating pump assembly (generally referred to by the reference numeral 10) including a power end portion 12 and a fluid end portion 14 operably coupled thereto. The power end portion 12 includes a housing 16 in which a crankshaft (not shown) is disposed, as is known, the crankshaft being operably coupled to an engine or motor (not shown), as is known, which is configured to drive the crankshaft. The fluid end portion 14 includes a fluid end block 18, which is connected to the housing 16 via a plurality of stay rods 20. The fluid end block 18 includes a fluid inlet passage 22 and a fluid outlet passage 24, which are spaced in a parallel relation. A plurality of fluid end retainer nuts 26, one of which is shown in FIG. 1, is connected to the fluid end block 18 opposite the stay rods 20. A plurality of cover assemblies 28, one of which is shown in FIG. 1, is connected to the fluid end block 18 opposite the fluid inlet passage 22. A plunger rod assembly 30 extends out of the housing 16 and into the fluid end block 18.

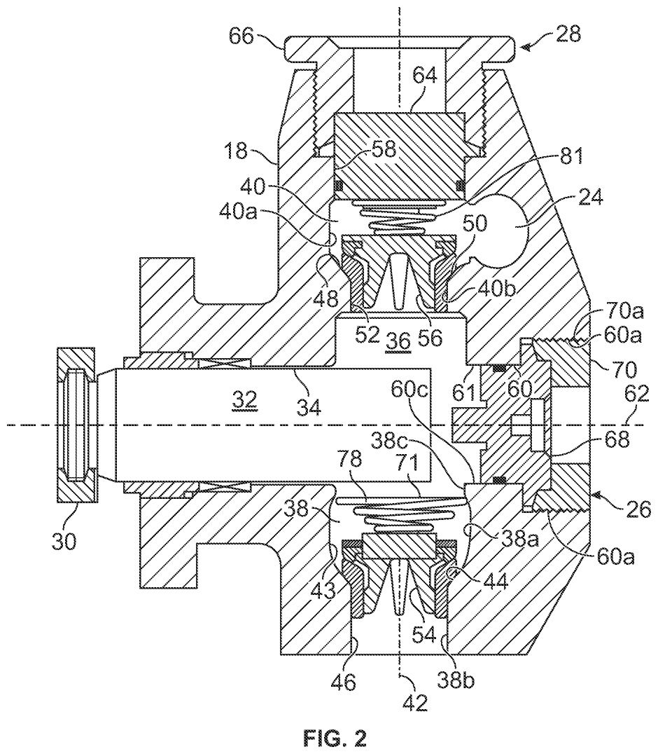

In embodiments, as illustrated in FIG. 2 with continuing reference to FIG. 1, the plunger rod assembly 30 includes a plunger 32, which extends through a bore 34 formed in the fluid end block 18, and into a pressure chamber 36 formed in the fluid end block 18. The plunger 32 is reciprocally disposed in the fluid chamber 36 to generate fluid pressure therewithin. In embodiments, a plurality of parallel-spaced bores may be formed in the fluid end block 18, with one of the bores being the bore 34, a plurality of pressure chambers may be formed in the fluid end block 18, with one of the pressure chambers being the pressure chamber 36, and a plurality of parallel-spaced plungers may extend through respective ones of the bores and into respective ones of the pressure chambers, with one of the plungers being the plunger 32.

The fluid end block 18 includes inlet and outlet fluid passages 38 and 40 formed therein, which are generally coaxial along a fluid passage axis 42. Under conditions to be described below, fluid flows from the inlet fluid passage 38 toward the outlet fluid passage 40 along the fluid passage axis 42. The fluid inlet passage 22 is in fluid communication with the pressure chamber 36 via the inlet fluid passage 38. The pressure chamber 36 is in fluid communication with the fluid outlet passage 24 via the outlet fluid passage 40.

The inlet fluid passage 38 includes an enlarged-diameter portion 38a and a reduced-diameter portion 38b extending downward therefrom (as in the figure), which direction may also be considered the upstream direction. Downstream from the enlarged-diameter portion 38a is an inlet fluid passage neck 38c, which is reduced in diameter relative to the enlarged-diameter portion.

The enlarged diameter portion 38a defines a tapered internal shoulder 43 and thus a frusto-conical surface 44 of the fluid end block 18. The reduced-diameter portion 38b defines an inside surface 46 of the fluid end block 18. Similarly, the outlet fluid passage 40 includes an enlarged-diameter portion 40a and a reduced-diameter portion 40b extending downward therefrom. The enlarged-diameter portion 40a defines a tapered internal shoulder 48 and thus a frusto-conical surface 50 of the fluid end block 18. The reduced-diameter portion 40b defines an inside surface 52 of the fluid end block 18. The frusto-conical surfaces 44, 50 form valve seats for respective inlet and outlet valves 54, 56.

An inlet valve 54 is disposed in the inlet fluid passage 38, and engages at least the frusto-conical surface 44 and the inside surface 46. Similarly, an outlet valve 56 is disposed in the outlet fluid passage 40, and engages at least the frusto-conical surface 50 and the inside surface 52. In an exemplary embodiment, each of valves 54 and 56 is a spring-loaded valve that is actuated by a predetermined differential pressure thereacross.

A counterbore 58 is formed in the fluid end block 18, and is generally coaxial with the outlet fluid passage 40 along the fluid passage axis 42. In embodiments, the fluid end block 18 may include a plurality of parallel-spaced counterbores, one of which may be the counterbore 58, with the quantity of counterbores equaling the quantity of plunger throws included in the pump assembly 10. The cover assembly 28 shown in FIGS. 1 and 2 includes at least a plug 64 and a fastener 66. In embodiments, the cover assembly 28 may be disconnected from the fluid end block 18 to provide access to, for example, the counterbore 58, the pressure chamber 36, the plunger 32, the outlet fluid passage 40 or the outlet valve 56. In embodiments, the pump assembly 10 may include a plurality of plugs, one of which is the plug 64, and a plurality of fasteners, one of which is the fastener 66, with the respective quantities of plugs and fasteners equaling the quantity of plunger throws included in the pump assembly 10.

A counterbore 60 is formed in the fluid end block 18, and is generally coaxial with the bore 34 along an axis 62. The counterbore 60 defines an internal shoulder 60a and includes an internal threaded connection 60b adjacent the internal shoulder 60a. In embodiments, the fluid end block 18 may include a plurality of parallel-spaced counterbores, one of which may be the counterbore 60, with the quantity of counterbores equaling the quantity of plunger throws included in the pump assembly 10.

A plug 68 is disposed in the counterbore 60, engaging the internal shoulder 60a and sealingly engaging an inside cylindrical surface defined by the reduced-diameter portion of the counterbore 60. In an exemplary embodiment, the plug 68 may be characterized as a suction cover. An external threaded connection 70a of a fastener 70 is threadably engaged with the internal threaded connection 60b of the counterbore 60 so that an end portion of the fastener 70 engages the plug 68. As a result, the fastener 70 sets or holds the plug 68 in place against the internal shoulder 60a defined by the counterbore 60, thereby maintaining the sealing engagement of the plug 68 against an inside cylindrical surface 61 defined by a reduced-diameter portion 60c of the counterbore 60. The retainer nut 26 shown in FIGS. 1 and 2 includes at least the plug 68 and the fastener 70. In embodiments, the retainer nut 26 may be disconnected from the fluid end block 18 to provide access to, for example, the counterbore 60, the pressure chamber 36, the plunger 32, the inlet fluid passage 38, or the inlet valve 54. The retainer nut 26 may then be reconnected to the fluid end block in accordance with the foregoing. In several exemplary embodiments, the pump assembly 10 may include a plurality of plugs, one of which is the plug 68, and a plurality of fasteners, one of which is the fastener 70, with the respective quantities of plugs and fasteners equaling the quantity of plunger throws included in the pump assembly 10.

Focusing now on the inlet fluid passage 38, a biasing member 71 is positioned within the inlet fluid passage 38. The biasing member 71 may be a coil spring as depicted or may be an equivalent biasing element, such as wave spring. In one embodiment the biasing member 71 is a conical coil spring. In some examples, the biasing member 71 may be a coil or other type of spring having an hourglass shape. In some examples, a cross-section of the biasing member 71 may be round, square, rectangular, or flat (e.g., shaped like a leaf spring).

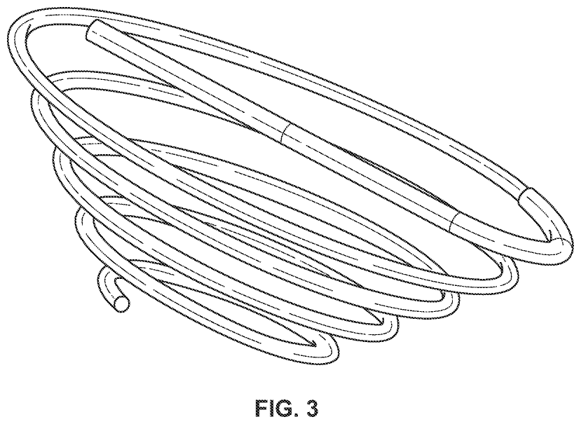

Referring also to FIGS. 3-6, the biasing member 71 includes a first end 72 with a first diameter and a second end 74 with a second diameter, where the first diameter is less than the second diameter. It will be understood that since the illustrated exemplary biasing member 71 is shown as a helical coil that the diameters of the first and second ends are measured laterally relative to the centerline shape of the coil, e.g., radially relative to the centerline 73 (FIG. 3).

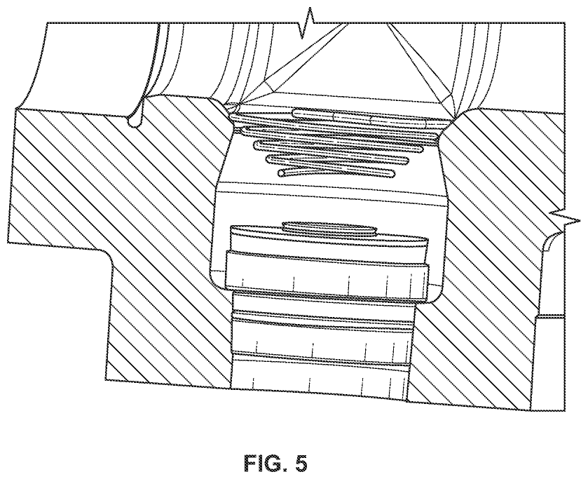

The first end 72 is positioned adjacent and in contact with the inlet valve 54 (FIG. 2). The inlet valve 54 may have an inlet valve boss 76 (FIG. 5) that is sized and shaped to receive and retain the first end 72 of the biasing member 71. In an embodiment, the inlet valve boss 76 is a cylindrical protrusion, projection, post, lug, dowel, or shaft, for example, that receives and retains the coiled first end 72.

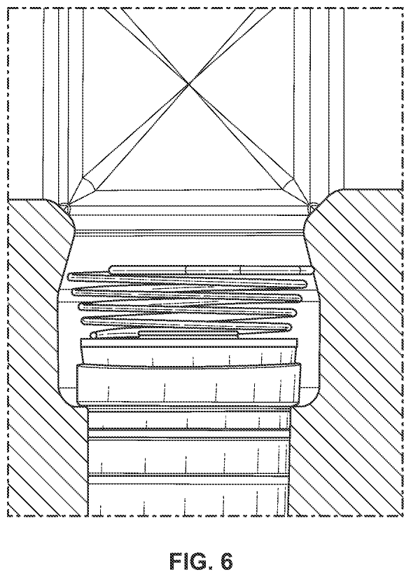

The second end 74 is sized such that when positioned within the enlarged diameter portion 38a, the relatively reduced diameter of the inlet fluid passage neck 38c traps the biasing member 71 within the inlet fluid passage 38 without any requirement for a retainer/valve stop. As shown in FIG. 2, the second end diameter of the biasing member 71 (e.g., an outer diameter at the second end 74) is greater than an inner diameter of the neck 38c. It will be understood, therefore, that the geometry of the inlet valve passage 38, in combination with the size and shape of the biasing member 71, forms a means of preventing the biasing member 71 from being displaced from its installed position within the inlet valve passage 38 without the need for a separate retainer. As shown in FIG. 6, the biasing member 71 may be positioned so as to retain the second end 74 inside and against the neck 38c when installed.

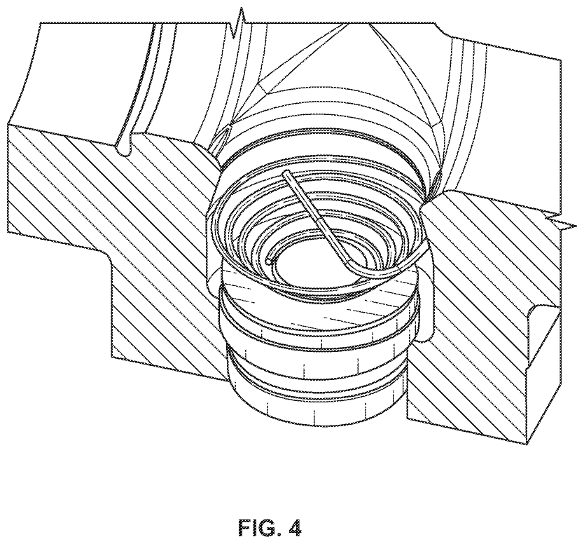

The biasing member 71 also has a gripping section or tang 78 formed at the second end 74 (FIG. 4). The tang 78 may extend at any angle relative to the centerline. In the example shown in FIG. 4, the tang 78 of the biasing member 71 extends in a direction that is normal to the centerline, i.e., radially relative to the centerline 73 (FIG. 3). The tang 78 is used by gripping with a tool to install the biasing member 71 into the inlet fluid passage 38 much in the same fashion as installing a Heli-Coil. The normal angle of the tang 78 shown in FIG. 4 may simplify the tool design for gripping the tang 78. The tang 78 may be a straight section formed of the spring material that constitutes the spring or it may be a thickened section of spring material. The tang 78 may extend from one side of the coil to the other in a generally radial direction to provide a gripping means without interfering with or potentially damaging the actual spring part of the biasing member 71. While there is no need in the present device to provide the biasing member 71 with a self-tapping feature, it will be understood that the helical shape of the biasing member enables the installation thereof by a threading process or procedure into the inlet fluid passage 38 until the entire body of the biasing member 71 is contained with the passage. In effect, the shape and size of the neck 38c functions as an internal thread into which the coil spring shape of the biasing member 71 may be threadably inserted into the inlet fluid passage 38. The tool (not shown) may have a gripping end or hole that grips or satisfactorily receives the tang 78. It is also contemplated that the biasing member 71 could be installed manually, whereby the tang 78 could be manually gripped and rotated by hand should the openings in the fluid end 14 permit.

When installed as shown in FIG. 2, the biasing member 71 exerts a selected biasing force on the inlet valve 54 that holds the inlet valve against the frusto-conical surface 44 to create a closed or sealed condition. When a pressure differential on the inlet valve 54 exceeds the closing force generated by the biasing member 71, the inlet valve opens and permits fluid media to enter the fluid chamber 36.

Referring again to FIG. 2, a biasing member 81 is positioned within the outlet fluid passage 40. The biasing member 81 may be any type of spring described above in relation to the biasing member 71. The biasing member 81 includes a first end positioned adjacent and in contact with the outlet valve 56 with a first diameter and a second end positioned adjacent and in contact with the plug 64 with a second diameter, where the first diameter is less than the second diameter.

### INDUSTRIAL APPLICABILITY

The industrial applicability of the system described herein will be readily appreciated from the forgoing discussion. The foregoing discussion is applicable to fluid ends of reciprocating pump assemblies, in particular, for pumping fluid media in fracturing operations and similar applications.

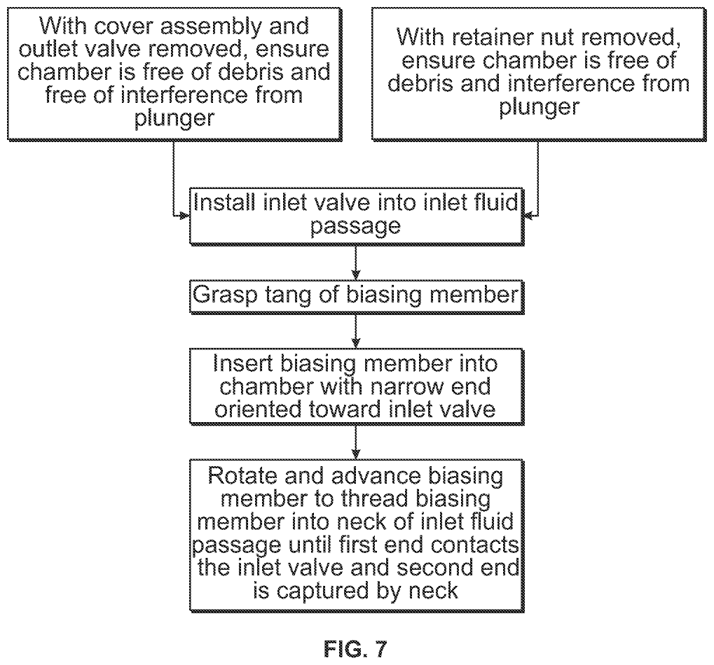

One example of the industrial application of the system according to embodiments of the disclosure, and referring also to FIGS. 1-6, a method of installing a biasing member 71 into an inlet fluid passage 38 is illustrated in FIG. 7. Step 100 illustrates a step wherein the biasing member 71 is installed through the opening normally occupied by the cover assembly 28. With the cover assembly and outlet valve removed, the chamber 36 may be inspected or visually checked or cleaned/treated to ensure that there is no debris or undesirable material in the chamber. Strictly speaking, the inspection step may not be necessary, but it will be understood that debris in the chamber 36 may interfere with proper positioning of the internal components of the fluid end 14. The chamber 36 is also checked and any necessary adjustments made to the position of the plunger 32 to ensure clear access to the interior of the fluid end block 18.

Alternatively, step 102 illustrates a step wherein the biasing member 71 is installed through the opening normally occupied by the retainer nut 26. With the retainer nut 26 removed, the chamber 36 may be visually checked or treated to ensure that there is no debris or undesirable material in the chamber. The chamber 36 is also checked and any necessary adjustments made to the position of the plunger 32 to ensure clear access to the interior of the fluid end block 18.

The inlet valve 54 is positioned within the inlet fluid passage 38 in step 104 regardless of the direction of access to the chamber 36. The biasing member 71 may be grasped by the tang 78 in step 106. The biasing member 71 is inserted into the chamber 36 with the narrow, first end 72 oriented toward the boss 76 of the installed inlet valve 54 in step 108.

The biasing member 71 is rotated in a direction that enables the biasing member to engage the neck 38c of the inlet fluid passage 38 and permit advancement of the biasing member into the enlarged diameter 38a of the inlet fluid passage by threading the biasing member through the neck in step 110. When the first end 72 is brought into contact with the inlet valve 54 and the second end 74 is threaded fully within the enlarged diameter 38a of the inlet fluid passage 38, and the entire biasing member 71 is captured within the inlet fluid passage the installation is completed. In the installed position, the biasing member 71 exerts a specified preload on the inlet valve 54.

As described above, the biasing member 71 can be installed within the inlet fluid passage 38 without any requirement for a separate retainer/valve stop. Therefore, embodiments disclosed herein can reduce risks associated with cracking, loosening and/or loss of a separate retainer/valve stop. Furthermore, methods of installing the biasing member 71 into an inlet fluid passage 38 described herein may be safer and/or faster compared to methods associated with the installation of a separate retainer/valve stop.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B″) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A fluid end of a reciprocating pump assembly, comprising:
a fluid end block defining a fluid chamber;
a plunger reciprocally disposed in the fluid chamber to generate fluid pressure therewithin;
an outlet fluid passage formed in the fluid end block in fluid communication with the fluid chamber;
an inlet fluid passage formed in the fluid end block in fluid communication with the fluid chamber, the inlet fluid passage including a valve seat, an enlarged diameter downstream from the valve seat, and a neck downstream of the enlarged diameter, the neck having a lesser diameter than the enlarged diameter;
an inlet valve movably disposed in the inlet fluid passage and sized and shaped to seal against the valve seat; and
a biasing member having a first end with a first diameter disposed on the inlet valve and a second end with a second diameter disposed within the enlarged diameter and seated inside and against the neck, the second end diameter being greater than the lesser diameter of the neck so as to be retained thereby within the inlet fluid passage.

2. The pump assembly of claim 1 wherein the biasing member is a coil spring.

3. The pump assembly of claim 2 wherein the biasing member is a conical coil spring.

4. The pump assembly of claim 2 further comprising a boss formed on the inlet valve, wherein the first end of the biasing member is sized and shaped to engage the boss.

5. The pump assembly of claim 4 wherein the boss is cylindrical.

6. The pump assembly of claim 2 wherein the biasing member includes a tang that is sized and shaped to be engaged and is configured to enable the rotation of the biasing member.

7. The pump assembly of claim 6 wherein the biasing member includes a centerline and the tang is configured to enable the rotation of the biasing member about the centerline.

8. The pump assembly of claim 7 wherein the tang is disposed at the second end of the biasing member.

9. The pump assembly of claim 8 wherein the tang is a generally straight shaped portion of the biasing member.

10. The pump assembly of claim 9 wherein the tang extends across the second end in a generally radial direction normal to the centerline.

11. The pump assembly of claim 1 wherein the first end has a lesser diameter than the second end.

12. The pump assembly of claim 1 wherein the inlet fluid passage is free of a separate valve spring retainer.

13. A reciprocating pump assembly, comprising:
a power end; and
a fluid end operatively connected to the power end, the fluid end comprising:
a fluid end block defining a fluid chamber;
a plunger reciprocally disposed in the fluid chamber to generate fluid pressure therewithin;
an outlet fluid passage formed in the fluid end block in fluid communication with the fluid chamber;
an inlet fluid passage formed in the fluid end block in fluid communication with the fluid chamber, the inlet fluid passage including a valve seat, an enlarged diameter downstream from the valve seat, and a neck downstream of the enlarged diameter, the neck having a lesser diameter than the enlarged diameter;
an inlet valve movably disposed in the inlet fluid passage and sized and shaped to seal against the valve seat; and
a biasing member having a first end with a first diameter disposed on the inlet valve and a second end with a second diameter disposed within the enlarged diameter and seated inside and against the neck, the second end diameter being greater than the lesser diameter of the neck so as to be retained thereby within the inlet fluid passage.

14. A method of assembling an inlet valve for a fluid end of a reciprocating pump assembly, the method comprising:
enabling access to a chamber of the fluid end;
installing an inlet valve into an inlet fluid passage of the fluid end;
inserting a biasing member into the chamber; and
advancing the biasing member into an installed position within the inlet fluid passage by rotating the biasing member, a first end of the biasing member is engaged with the inlet valve in the installed position, and a second end of the biasing member is engaged with a neck of the inlet fluid passage in the installed position, wherein the engagement of the second end and the neck holds the biasing member in the inlet fluid passage.

15. The method of claim 14 wherein said enabling access includes at least one of removing a cover assembly from a fluid end block of the fluid end or removing a retainer nut from the fluid end block of the fluid end.

16. The method of claim 14 wherein the inlet fluid passage includes an enlarged diameter formed downstream from a reduced diameter, wherein at least a part of the reduced diameter is sized and shaped to form a valve seat for sealing engagement with the inlet valve.

17. The method of claim 16 wherein the neck of the inlet fluid passage is formed downstream from the enlarged diameter.

18. The method of claim 14 wherein the biasing member is a conical coil spring.

19. The method of claim 14 wherein the first end has a lesser diameter than the second end.

20. The method of claim 19 wherein the second end has a diameter greater than a diameter of the neck.
